(19) United States
(12) Patent Application Publication
(10) Pub. No.: US 2003/0156717 A1
(43) Pub. Date: Aug. 21, 2003

(54) Copy-protection by preserving copy-control signals

(75) Inventor: Michael Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/164,672

(22) Filed: Jun. 7, 2002

Related U.S. Application Data
(60) Provisional application No. 60/359,050, filed on Feb. 21, 2002.

(51) Int. Cl. H04N 7/167

(52) U.S. Cl. 380/203

(57) ABSTRACT

A method and system that prevents wide-scale distribution of content material relies upon the use of a copy-protection signal that is associated with the content material. A compliant device is configured to enforce appropriate copy-protection safeguards based on the presence or absence of the copy-protection signal. If a compliant device produces a copy of the copy-protected material, the compliant device is configured to assure that the copy-protection signal is contained within the produced copy and in subsequent retransmissions and rerecordings in a local environment. To prevent wide-scale distribution of copy-protected material, compliant devices are configured to prevent communication of the copy-protected material to wide-area networks, such as the Internet. Because the compliant devices are configured to maintain the copy-protection signal, and to control the distribution of material that contains this signal, the wide-scale distribution of protected content material is avoided. Because the protection provided is limited to preventing wide-scale distribution, adverse consumer reactions to the imposed use of a copy-protection scheme are minimized.

This application claims the benefit of U.S. Provisional Patent Application No. 60/359,050, filed Feb. 21, 2002, Attorney Docket US020054P.

### BACKGROUND OF THE INVENTION

1. Field of the Invention

This invention relates to the field of copy protection systems, and in particular to a system that is intended to prevent wide-scale distribution of protected content material.

2. Description of Related Art

With the advent of relatively inexpensive means of reproducing and distributing digitally recorded material, the protection of copy-protected material, such as recordings of artistic performances, has become of primary importance to the holders of the rights to copy the material. Conversely, purchasers of copy-protected material expect to be able to freely copy the purchased material for their own use.

It has become a common practice for many purchasers of content material to make the content material widely available to others, thereby depriving the holder of the rights to copy the material from substantial revenues. This practice of wide-scale distribution of copy-protected material has been substantially facilitated by such systems as Napster, Kaza, Gnutella, and so on, that allow users to widely advertise the availability of the content material, and to freely obtain copies of the available material.

A variety of systems and methods have been proposed for the protection of copy-protected content material, typically via the use of encryption. Some or all of the content material, or ancillary material that is necessary to access the content material, is encrypted. Authorized recipients of the material are provided means for decrypting the encrypted material, while unauthorized recipients are unable to decrypt the encrypted material without a substantial investment of time or materials. As long as the cost of an unauthorized decryption exceeds the benefits that are derivable from the unauthorized decryption, the copy-protected material will generally remain protected.

The cost of providing the aforementioned protection, however, can be substantial. Timely decryption by authorized users often requires a substantial amount of processing power, thereby increasing the cost of consumer electronic devices that are designed to comply with the copy-protection scheme. Similarly, the processes used to manage the distribution and control of the keys that are used to enable only authorized recipients to decrypt the material can be expected to introduce additional infrastructure overhead and complexity, the cost of which will be passed to the consumers.

The complexities of conventional copy-protection schemes that are based on encryption also introduce an increased risk of failure. Of particular concern is the failure of the decryption process for authorized use. Consumers will not tolerate protection schemes that erroneously prevent their authorized use of purchased content material, and the likelihood of such erroneous behavior can be expected to be highly dependent upon the degree of complexity of the protection scheme. Holders of the rights to copy the protected material are generally in the business of selling copies of the protected material, and it is generally recognized that an unreliable system for providing authorized access will have a substantially detrimental effect on sales.

### BRIEF SUMMARY OF THE INVENTION

It is an object of this invention to provide a method and system for protecting copy-protected content material from wide-scale distribution. It is a further object of this invention to provide this method and system at a minimal cost. It is a further object of this invention to minimize the complexity of protecting copy-protected content material from wide-scale distribution.

These objects and others are achieved by providing a method and system that preserves a copy-protection signal that is contained within unencrypted copy-protected material. A compliant device is configured to enforce appropriate copy-protection safeguards based on the presence or absence of this copy-protection signal. If a compliant device produces a copy of the copy-protected material, the compliant device is configured to assure that the copy-protection signal is contained within the produced copy. To prevent wide-scale distribution of copy-protected material, compliant devices are configured to prevent communication of the copy-protected material to wide-area networks, such as the Internet. Because the compliant devices are configured to maintain the copy-protection signal, and to control the distribution of material that contains this signal, the “innocent” wide-scale distribution of protected content material is avoided. That is, most users of compliant devices are not expected to purposely modify the device to overcome the wide-scale distribution protection that is provided by this invention, and therefore a substantial reduction in wide-scale distribution can be expected, without the cost and complexities associated with encryption and decryption systems. Because the protection provided is limited to preventing wide-scale distribution, adverse consumer reactions to the imposed use of a copy-protection scheme are minimized.

### BRIEF DESCRIPTION OF THE DRAWINGS

The invention is explained in further detail, and by way of example, with reference to the accompanying drawings wherein:

FIG. 1 illustrates an example flow diagram of a copy-protection system in accordance with this invention.

FIG. 2 illustrates an example block diagram of a system that embodies a copy-protection system in accordance with this invention.

Throughout the drawings, the same reference numerals indicate similar or corresponding features or functions.

### DETAILED DESCRIPTION OF THE INVENTION

This invention is premised on the observation that most purchasers of copy-protected content material do not purchase the material with the specific intent of widely distributing the protected material. Furthermore, most purchasers of copy-protected content material do not have strong feelings, one way of the other, concerning copy-protection rights. Typical purchasers desire unlimited rights to copy the material for their personal use, but their decision to purchase the material will not be affected by a limitation in their ability to widely distribute the purchased material.

In accordance with this invention, compliant devices are configured to automatically prevent the distribution of copy-protected material to a wide-area network, and specifically, to prevent the distribution of copy-protected material via the Internet. Other distributions, including the creation of copies of the copy-protected material, are not constrained by the compliant devices, thereby allowing purchasers of the copy-protected material virtually unlimited copying rights for their own use. Some purchasers may use the compliant devices to provide copies to friends or associates, but in most cases, such distributions will be limited, and will not have a substantial impact on the sales of the protected material, relative to the impact that current wide-scale distribution schemes currently have on sales.

In further accordance with this invention, encryption is not used, thereby minimizing the cost and complexity of this copy-protection scheme. It is recognized that the lack of encryption will allow an illicit user to widely distribute the content material by merely using a non-compliant device. This invention is further premised on the assumption that most purchasers will not modify a compliant device to overcome the protection scheme of this invention. Therefore, it is expected that the impact on sales of the protected material caused by the illicit wide-scale distribution by relatively few purchasers will also be minimal, compared to the currently common practice of wide-scale distribution by any purchaser.

By avoiding the complexities of encryption, the cost of a compliant device will not be substantially different from existing devices, and consumer and industry acceptance of this copy protection scheme will not be impaired by cost concerns. By avoiding the complexities of encryption, and limiting the restrictions of the copy-protection to wide-scale distribution means, the likelihood of a failure that prevents an authorized user from access to the material is virtually eliminated in a system that is designed in accordance with the principles of this invention. By enforcing the prevention of wide-scale distribution by most purchasers, via the use of compliant devices, the primary concern of holders of rights to copy-protected material is addressed.

Furthermore, because encryption is not required, the copy protection scheme of this invention can be extended to include media that does not generally provide copy protection, such as broadcast television or radio. For example, although a song may be broadcast by a local radio station, compliant devices will prevent the broadcast song from being re-distributed via the Internet. Holders of rights to copy-protected material allow public broadcast of the content material because copying a song from a broadcast is a particularly inefficient means of obtaining content material, due to the inherent inability to ‘target’ a desired song, and because sales are expected to increase when a song is frequently broadcast. Once a copied song is provided on the Internet, on the other hand, a user is free to search for the desired song and copy it at any convenient time, thereby making it a particularly efficient means of obtaining protected content material. In accordance with this invention, if the material is broadcast with an associated copy-protect protect signal, compliant devices will prevent the distribution of copies of this broadcast material to the Internet. Because the broadcast material is not encrypted, it will be freely played through conventional broadcast receivers.

In a preferred embodiment of this invention, a copy-protection signal is incorporated into the protected content material. If the content material is digitally encoded, this copy-protection signal can be as simple as a bit, or set of bits, that indicate whether or not the material is protected. This bit or set of bits are preferably encoded as “out-of-band” data, so that the quality of the content material is not affected; alternatively, because the copy-protection signal may be as short as a single bit, it can be included in the content material without introducing noticeable distortion. If the content material is analog, a watermark can be used to mark it as copy-protected material, using techniques common in the art. In like manner, digitally encoded material may also use a watermark to indicate its copy-protection status.

Preferably, the copy-protection signal is easy to detect, and durable. The advantage of using a watermark is that most watermarking techniques are structured to retain at least some portion of the watermark, regardless of distortions that may be introduced into the protected material. Only if the protected material is distorted beyond viable use will the watermark be undetectable. The advantage of using multiple bits, compared to a single bit, is to provide increased reliability in the presence of some distortion. Statistical techniques, common in the art, can be applied to determine whether a set of bits corresponds to one state or another (protected or un-protected), even some or all of the bits are corrupted by distortions.

As noted above, this invention is intended to prevent the wide-scale distribution of protected material by purchasers who are not specifically intent on subverting a copy-protection scheme, provided that the scheme does not interfere with their perceived right of unlimited access to the material for their personal use. To support the premise of this invention, the copy-protection signal of this invention is used to prevent the communication of material that contains the copy-protection signal via a network that facilitates wide-scale distribution, such as the Internet. Because the copy-protection signal is used in this limited capacity, to only block communication to select communication channels, the criteria, or threshold, used to determine whether particular material contains the copy-protection signal can be set quite low, thereby improving the effective durability of the copy-protection signal. Note that this is contrary to most conventional copy-protection systems, and particularly encryption-based systems. In a conventional system, the consequences of erroneously determining that material is copy-protected, or that the current use of the material is not an authorized, can be expected to be devastating to the public's acceptance of copy protection systems. As such, when the evidence of copy protection is ambiguous, conventional copy-protection systems are configured to determine that the material is not copy-protected. Because the consequences of an erroneous determination of the copy-protection status in this invention are relatively minor to most users, the copy-protection system of this invention can be configured to determine that the material is copy-protected, even if the evidence of copy protection is ambiguous.

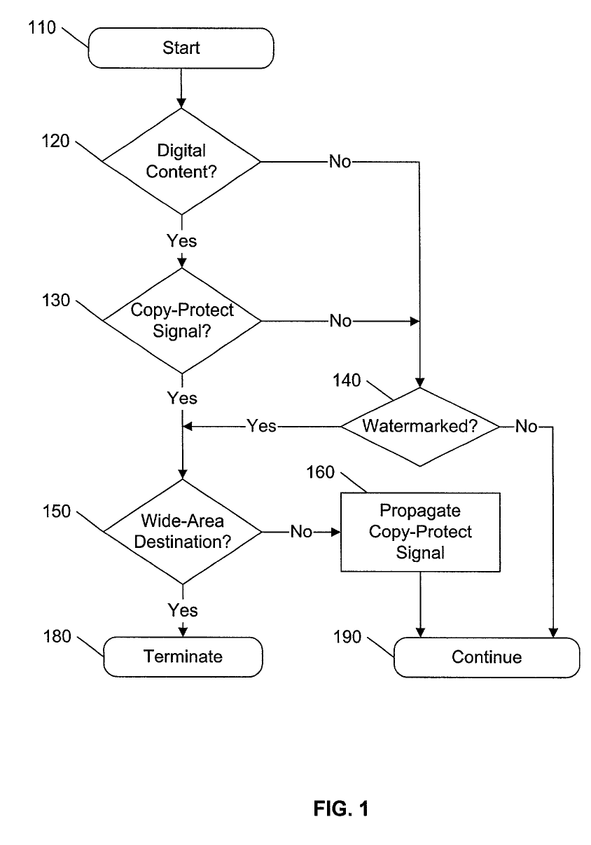

FIG. 1 illustrates an example flow diagram of a copy-protection system in accordance with this invention. The process starts at 110, when content material is presented to the system. If, at 120, the content is determined to be digitally encoded, the system determines whether the copy-protection signal is present. If, at 130, the copy-protection signal is detected, the system determines whether the protected material is targeted to enter a wide-area network, such as the Internet, at 150. If, at 150, the protected material is determined to be destined for a wide-area network, the process is terminated, at 180, so that the protected material is prevented from distribution to the wide-area network.

If, at 120, the content material is determined not to be digitally encoded, or, at 130, the copy-protection signal is not detected in the digitally encoded content material, the system is configured to determine whether a watermark is present, at 140. The detection of a watermark, at 140, is equivalent to the detection of a copy-protection signal in a digital encoding, at 130, and the process continues at 150. That is, the watermark merely forms one type of copy-protection signal. If neither a copy-protection signal nor a watermark is detected, the content is unmarked, and the process continues at 190. The block 190 corresponds to a continuation of the desired process on the content material, such as recording a copy of the material, transmitting the material to a network, and so on.

If, at 150, the protected material is not destined for wide-area distribution, the copy-protection system assures that the copy-protection signal is propagated to whatever the next destination is, at 160, and the process continues, at 190. That is, for example, if the copy-protection system is embodied in a device that produces a removable copy of the protected material, such as a compact disc, the block at 160 assures that the copy that will be recorded at the block 190 contains the copy-protection signal. Preferably, the actions represented by the block 160 are integral to the recording process, although a separate pre-process or post-process set of actions may be employed.

Note that the copy-protection signal that is attached to the propagated material, at 160, need not be the same as the copy-protection signal that was used to mark the original content material. For example, a system may be configured to detect any of a number of different types of copy-protection signals, at 130, 140, but, to minimize cost and complexity, may be configured to only produce one type of copy-protection signal at 160. In like manner, the copy-protection system may be configured to propagate the original copy-protection signal as well as adding another type of copy-protection signal. Similarly, if a watermark is detected, this watermark will continue to exist; however, an other copy protection signal may be added to the content material, at 160.

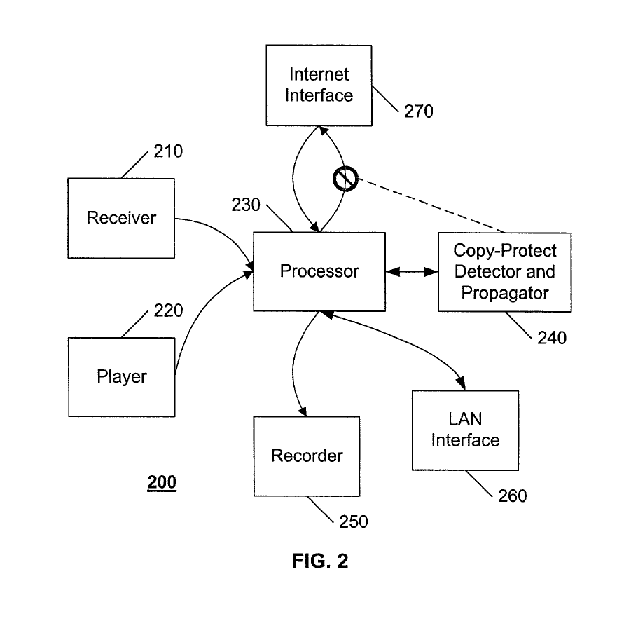

FIG. 2 illustrates an example block diagram of a system 200 that embodies a copy-protection system in accordance with this invention. The system 200 is illustrated using the paradigm of a typical computer device that includes one or more devices 210, 220 for receiving content material, one or more devices 250 for recording copies of the content material, and one or more communications devices 260, 270 for transmitting the content material to other devices. As will be evident to one of ordinary skill in the art, the principles of this invention are equally applicable to systems have fewer or more components and devices than those illustrated in the system 200.

The system 200 includes a processor 230, and a copy-protection detector 240. Although illustrated as two discrete components 230, 240, one of ordinary skill in the art will recognize that the functions provided by the components 230, 240 may be distributed among more or fewer components, depending upon the particular system configuration and architecture. The copy-protection detector 240 is configured to effect the copy-protection scheme detailed above with respect to FIG. 1. That is, for example, the copy-protection detector 240 is configured to prevent copy protected material from being provided to the Internet via the Internet interface 270, and to assure that the copy-protection signal is attached to the content material when it is communicated to the recorder 250 or the interface 260 to a local area network (LAN). Note that, in a preferred embodiment, the copy-protection detector 240 is configured to enforce the copy-protection scheme, detailed above, regardless of the source 210, 220, 260, or 270 of the received content material.

Optionally, the copy-protection detector 240 may also be configured to prevent the rendering or subsequent propagation of protected content material that is received from a wide-area network, such as the Internet interface 270.

Of particular note, the copy-protection scheme of this invention is wholly compatible with existing non-compliant systems. Because the content material is unencrypted, existing conventional systems, such as personal computers, MPEG players, and the like, will continue to be able to render or otherwise process the unencrypted content material. As noted above, the copy-protection signal is attached to the unencrypted content material in a manner that does not affect the quality of the material when it is rendered.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A method for protecting wide-scale distribution of content material, comprising:
detecting a copy-protection signal associated with the content material, and if the copy-protection signal is detected and if the content material is destined for a wide-area network:
preventing communication of the content material to the wide-area network, otherwise:
allowing communication of the content material to its intended destination.

2. The method of claim 1, wherein the content material is unencrypted.

3. The method of claim 1, further including assuring that the copy-protection signal is associated with each copy of the content material.

4. The method of claim 1, further including assuring that an other copy-protection signal is associated with each copy of the content material.

5. The method of claim 1, wherein
the copy-protection signal includes at least one of:
one or more bits in a digital encoding of the content material, and
a watermark that is associated with the content material.

6. A copy-protection system comprising:
a receiving device that is configured to receive content material, and
a copy-protection detector that is configured to detect a copy-protection signal in the content material,
wherein
the copy-protection detector is further configured to prevent communication of the content material to a wide-area network if the
copy-protection signal is detected, and otherwise to allow communication of the content material.

7. The copy-protection system of claim 6, wherein the content material is unencrypted.

8. The copy-protection system of claim 6, wherein
the receiving device includes at least one of:
a broadcast receiver,
a playback device, and
a network interface.

9. The copy-protection system of claim 6, further including:
a transmission device that is configured to provide the communication of the content material.

10. The copy-protection system of claim 9, wherein
the transmission device includes at least one of:
a recording device, and
a network interface.

11. The copy-protection system of claim 6, wherein
the copy-protection detector is further configured to attach at least one of the copy-protection signal and an other copy-protection signal to each copy of the content material that is communicated.

12. The copy-protection system of claim 6, wherein
the copy-protection signal includes at least one of:
one or more bits in a digital encoding of the content material, and
a watermark that is associated with the content material.

13. Media comprising:
content material that is suitable for rendering, and
a copy-protection signal that is associated with the content material and is configured to effect a prevention of communication of the content material to a wide-area network when the media is presented to a compliant copy-protection device.

14. The media of claim 13, wherein
the content material is unencrypted.

15. The media of claim 13, wherein
the copy-protection signal includes at least one of:
one or more bits in a digital encoding of the content material, and
a watermark that is associated with the content material.
